(19) United States
(12) Patent Application Publication
(10) Pub. No.: US 2024/0170845 A1
(43) Pub. Date: May 23, 2024

(54) ANTENNA DEVICE

(71) Applicant: YOKOWO CO., LTD., Chiyoda-ku, Tokyo (JP)

(72) Inventors: Takashi NOZAKI, Tomioka-Shi, Gunma (JP); Noritaka TERASHITA, Tomioka-Shi, Gunma (JP)

(73) Assignee: YOKOWO CO., LTD., Chiyoda-ku, Tokyo (JP)

(21) Appl. No.: 18/283,451

(22) PCT Filed: Jan. 28, 2022
(86) PCT No.: PCT/JP2022/003304

§ 371 Date: Sep. 22, 2023

Related U.S. Application Data
(60) Provisional application No. 63/165,795, filed on Mar. 25, 2021.

(51) Int. Cl. H01Q 5/371; H01Q 1/52; H01Q 9/04

(52) U.S. Cl. CPC H01Q 5/371; H01Q 1/521; H01Q 9/0421; H01Q 9/0414

(57) ABSTRACT

An antenna device including a ground part; an antenna, including a body part having an open end facing and open to the ground part and a feed part extending from the body part in a direction of the ground part and having a feed point; and a parasitic element for impedance adjustment of the antenna, including a first end located at a distance from the open end.

### TECHNICAL FIELD

The present disclosure relates to an antenna device.

### BACKGROUND ART

Patent Literature 1 discloses an integrated antenna.

### CITATION LIST

### Patent Literature

Patent Literature 1: JP 2010-81500A

### SUMMARY OF INVENTION

### Technical Problem

Each of a first telephone antenna and a second telephone antenna in the integrated antenna disclosed in Patent Literature 1 supports a limited frequency band and is not capable of supporting radio waves in a wide band.

In view of the above problem, an example of an object of the present disclosure is to provide an antenna device capable of supporting radio waves in a wide frequency band.

### Solution to Problem

An aspect of the present disclosure is an antenna device including a ground part; an antenna, including a body part having an open end facing and open to the ground part and a feed part extending from the body part in a direction of the ground part and having a feed point; and a parasitic element for impedance adjustment of the antenna, having a first end located at a distance from the open end.

According to one aspect of the present disclosure, it is possible to provide an antenna device capable of supporting radio waves in a wide frequency band.

### BRIEF DESCRIPTION OF DRAWINGS

FIGS. 1A-1C illustrate perspective views of an antenna device 1 of a first embodiment viewed from a left-rear side (FIG. 1A), a right-front side (FIG. 1B), and a right-rear side (FIG. 1C).

FIGS. 2A-2B illustrate schematic views of an antenna 2 and illustrate a case where the length of an antenna 20 is set at a half-wavelength of a supported frequency band (FIG. 2A) and a case where the length of the antenna 20 is set at a quarter-wavelength of the supported frequency band (FIG. 1B).

FIGS. 3A-3B illustrate Smith charts illustrating impedance characteristics of an antenna 10 in a case without a parasitic element 30 (FIG. 3A) and a case with the parasitic element 30 (FIG. 3B).

FIG. 4 is a Smith chart illustrating impedance characteristics of the antenna 10 in a case without the parasitic element 30.

FIG. 5 is a Smith chart illustrating impedance characteristics of the antenna 10 in a case with the parasitic element 30.

FIG. 6 is a Smith chart illustrating impedance characteristics of the antenna 10 in a case with the parasitic element 30 and where a capacitor is connected in series with the antenna 10.

FIG. 7 is a graph illustrating a relationship of VSWR with respect to frequency in the antenna device 1.

FIG. 8A is a diagram illustrating an example of the antenna device 1, and FIG. 8B is a Smith chart illustrating impedance characteristics of the antenna 10 when the distance between the parasitic element 30 and the antenna 10 is changed.

FIG. 9A is a diagram illustrating an example of the antenna device 1, and FIG. 9B is a Smith chart illustrating impedance characteristics of the antenna 10 when the front-rear length of the parasitic element 30 is changed.

FIG. 10A is a diagram illustrating an example of the antenna device 1, and FIG. 10B is a Smith chart illustrating impedance characteristics of the antenna 10 when the front-rear length of the parasitic element 30 is changed.

FIG. 11A is a diagram illustrating an example of the antenna device 1, and FIG. 11B is a Smith chart illustrating impedance characteristics of the antenna 10 when the width of the parasitic element 30 is changed.

FIG. 12A is a diagram illustrating an example of the antenna device 1, and FIG. 12B is a Smith chart illustrating impedance characteristics of the antenna 10 when the width of the parasitic element 30 is changed.

FIG. 13A is a diagram illustrating an example of the antenna device 1, and FIG. 13B is a Smith chart illustrating impedance characteristics of the antenna 10.

FIG. 14A is a diagram illustrating an example of the antenna device 1, and FIG. 14B is a Smith chart illustrating impedance characteristics of the antenna 10.

FIG. 15A is a diagram illustrating an example of the antenna device 1, and FIG. 15B is a Smith chart illustrating impedance characteristics of the antenna 10.

FIG. 16 is an exploded perspective view of an antenna device 100 of a second embodiment.

FIGS. 17A-17B illustrates perspective views of the antenna device 100 of the second embodiment and illustrate a case where the antenna device 100 is viewed from a left-front side (FIG. 17A) and a case where the antenna device 100 is viewed from a right-front side (FIG. 17B).

### DESCRIPTION OF EMBODIMENTS

At least the following matters will become apparent from the present description and the accompanying drawings.

Hereinafter, preferred embodiments of the present disclosure will be described with reference to the drawings. The same or equivalent components, members, and the like illustrated in the drawings are denoted by the same reference numerals, and overlapping description thereof will be omitted as appropriate.

### First Embodiment

### <<Overview of Antenna Device 1>>

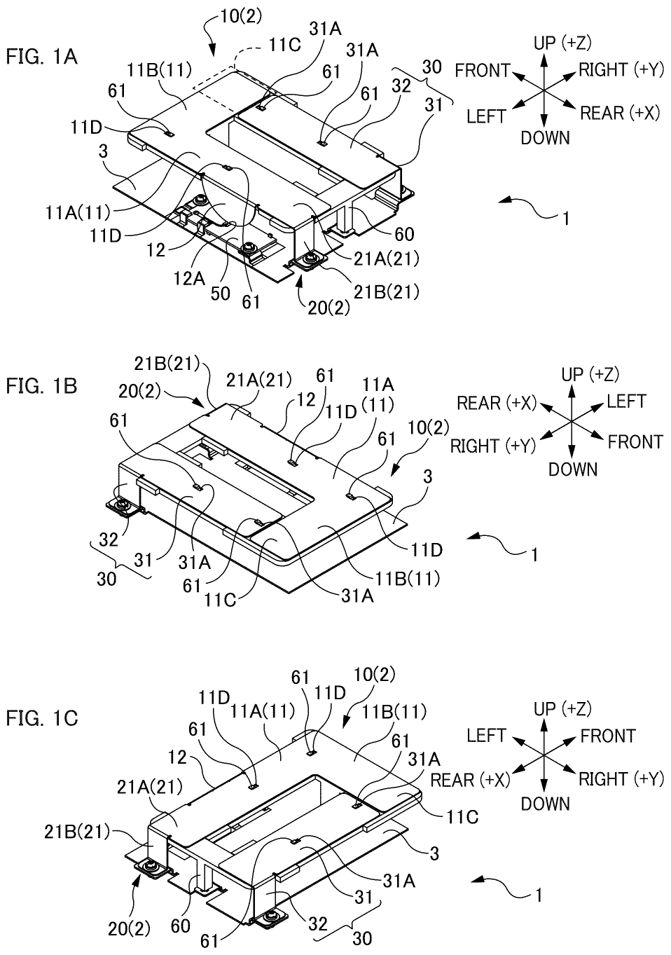

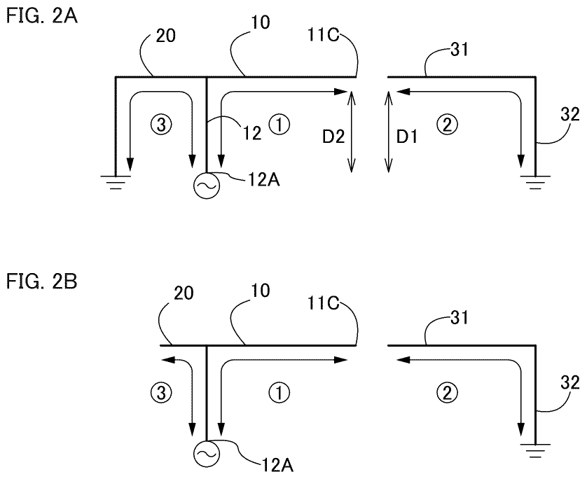

An overview of an antenna device 1 of the present embodiment will be given with reference to FIGS. 1A-1C and 2A-2B.

The antenna device 1 is a vehicle antenna device used in a vehicle (wheeled vehicle) not illustrated. In the present embodiment, the antenna device 1 is mounted on, for example, an upper surface (including a roof and a trunk door) of the vehicle, a lower part of the upper surface, or an inside of an instrument panel. However, the antenna device 1 may be located at a part of the vehicle other than the roof or the inside of the instrument panel, such as a spoiler of the vehicle or an overhead console. In addition, the antenna device 1 may be an antenna device for something other than a vehicle.

The antenna device 1 includes an antenna 2, a ground part 3, a parasitic element 30, a circuit board 50, and a holding member 60. The antenna 2 functions as two antennas capable of supporting respective different frequency bands. These two antennas are hereinafter referred to as an antenna 10 and an antenna 20. In addition, the antenna 2 includes a feed part 12 (described below) that functions as a third antenna.

In the following description, as illustrated in FIGS. 1A-1C, a direction from the ground part 3 toward the antenna 2 is defined as an up direction, and the reverse direction thereof is defined as a down direction. A direction in which an upper part of the parasitic element 30 (first extension part 31 to be described below) extends toward a second extension part 11B of an element 11 to be described below is defined as a front direction, and the reverse direction thereof is defined as a rear direction. A direction orthogonal to an up-down direction and a front-rear direction is defined as a left-right direction.

Note that, as illustrate in FIGS. 1A-1C, the front-rear direction may be referred to as an “X direction”, the left-right direction may be referred to as a “Y direction”, and the up-down direction may be referred to as a “Z direction”. The rear direction may be referred to as a +X direction, the left direction may be referred to as a +Y direction, and the up direction may be referred to as a +Z direction. The left-right direction may be referred to as a “lateral direction” or a “width direction”, and the up-down direction may be referred to as a “vertical direction” or a “height direction”.

Note that the above-described definitions of directions and the like are also common to the other embodiments in the present description unless otherwise specified.

### <Ground Part 3>

The ground part 3 functions as a ground of the antenna 2 and the parasitic element 30 included in the antenna device 1. However, alternatively the ground part 3 may function as a ground of only some of the antennas of the antenna 2. For example, the ground part 3 may function as a ground of the antenna 10, and another ground part may function as a ground of the antenna 20.

In the present embodiment, the ground part 3 is formed as an integral metal plate (sheet metal) as illustrated in FIGS. 1A-1C. However, alternatively the ground part 3 may be constituted of a plurality of separate metal plates. For example, the ground part 3 may have a configuration in which a metal plate on which the antenna 10 is provided and another metal plate on which the antenna 20 is provided are electrically connected.

Note that the ground part 3 may be formed in a shape other than a plate shape as long as it is a member that functions as a ground of the antenna(s) included in the antenna device 1. The ground part 3 may be configured by freely combining a metal member and a member made of a material other than metal as long as it functions as a ground of the antenna(s) included in the antenna device 1. For example, the ground part 3 may have a configuration including a metal plate and an insulator made of resin. Alternatively, the ground part 3 may be constituted of a single substrate in which a conductive pattern is formed on a printed-circuit board (PCB).

As illustrated in FIGS. 1A-1C, the ground part 3 is formed of a substantially quadrilateral member when viewed in the up-down direction. In the following description, “substantially quadrilateral” or “rectangular” refers to a shape consisted of four sides including, for example, a square and a rectangle, and for example, at least part of the corners may be cut out obliquely with respect to the sides, or at least part of the corners may include a curves. Further, a “substantially quadrilateral” or “rectangular” shape may be such that part of the sides may be provided with a notch (concave part) or a protrusion (convex part).

### <Antenna 10>

The antenna 10 is a wideband antenna for mobile communication based on an inverted-L antenna (cf. FIGS. 1A-1C and 2A-2B). In the present embodiment, the antenna 10 supports, for example, radio waves in the 699 MHz to 894 MHz band for GSM, UMTS, and LTE (corresponding to a “first frequency band”). However, the antenna 10 is not limited thereto and may support radio waves of only part (for example, only for 5G) of the frequency band for GSM, UMTS, LTE, and 5G.

In addition, the antenna 10 may support radio waves in a frequency band other than that for GSM, UMTS, and LTE. The antenna 10 may be an antenna supporting radio waves of a frequency band used for telematics, vehicle to everything (V2X) (vehicle-to-vehicle communication, road-to-vehicle communication), Wi-Fi, Bluetooth, and the like, for example. Note that Wi-Fi and Bluetooth are registered trademarks.

The antenna 10 includes the element 11 and the feed part 12. The element 11 is an element that resonates in a frequency band of the radio waves supported by the antenna 10, with the feed part 12. As illustrated in FIGS. 1A-1C, the element 11 is connected to an upper end of the feed part 12.

Note that being “connected” is not limited to being physically connected and includes being “electrically connected”. In addition, electrical connection is not limited to connection by a conductor and includes connection by an electronic circuit, an electronic component, or the like.

The element 11 is a plate-shaped member extending horizontally and faces the ground part 3 with the holding member 60 being interposed therebetween, and has a shape bent in an L shape in a front part when viewed from the top. The element 11 includes a first extension part 11A and the second extension part 11B.

The first extension part 11A is a part formed so as to extend forward from the feed part 12. The first extension part 11A is formed so as to face the ground part 3 in the up-down direction.

The second extension part 11B is a part extending in the right direction from a front part of the first extension part 11A. In the present embodiment, the element 11 forms a shape bent in the right direction when viewed from the top with the first extension part 11A and the second extension part 11B. An end 11C of the second extension part 11B forms an open end and faces, in the front-rear direction, a front-direction end of the parasitic element 30 at a distance as illustrated in FIGS. 1A-1C. Note that the term “end” does not mean an exact edge but means a certain region including the edge, as indicated by dotted lines in FIG. 1A.

The feed part 12 is a member on a flat plate formed so as to extend in the up direction from the circuit board 50. A feed point 12A electrically connected to the circuit board 50 is provided at a lower end of the feed part 12.

The feed part 12 has a substantially semicircular shape with an are formed in the down direction when viewed in the left-right direction. Hence, an upper end of the feed part 12 has a front-rear direction length (hereinafter, sometimes referred to as a width) longer than that of the lower end. Note that the shape of the feed part 12 is not limited to the semicircular shape and may be another shape, such as a polygonal shape, to have the front-rear direction length of the upper end of the feed part 12 longer than that of the lower end.

By increasing the front-rear direction length of the upper end of the feed part 12 (width of the feed part 12 when viewed in the left-right direction), the feed part 12 functions as an antenna supporting a 3.3 to 5 GHz frequency band (corresponding to a “second frequency band”).

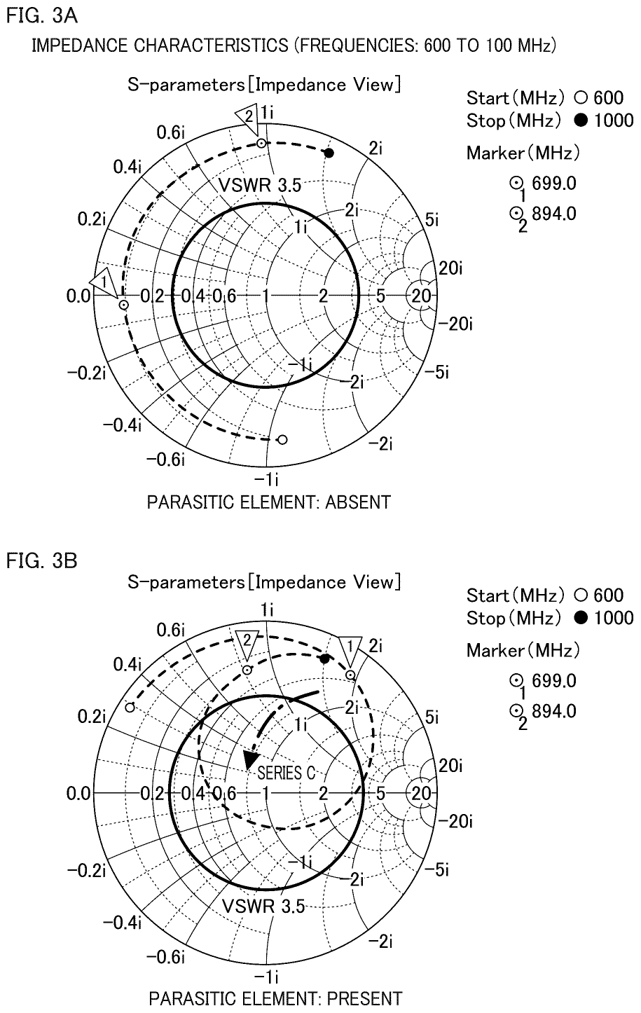

The length along the shape of the antenna 10 from the feed point 12A to the end 11C is equal to approximately a quarter-wavelength of radio waves in the 699 MHz to 894 MHz band (as an example, the center frequency, i.e., 699 MHz in the example in FIGS. 3A-3B) (indicated by the arrow indicated with a circled number 1 in FIGS. 2A-2B). By setting the length of the antenna 10 to be approximately a quarter-wavelength of the supported frequency band, the sensitivity of the antenna 10 in the supported frequency band can be improved.

<Antenna 20>

The antenna 20 is a wideband antenna for mobile communication based on a folded monopole antenna (cf. FIGS. 1A-1C and 2A-2B). In the present embodiment, the antenna 20, together with the feed part 12, receives radio waves in the 2 GHz band (for example, 1710 to 2170 MHz, corresponding to a “third frequency band”). However, the antenna 20 is not limited thereto and may support radio waves in part of the 2 GHz frequency band.

The antenna 20 may support radio waves in a frequency band for GSM, UMTS, LTE, and 5G. The antenna 20 may be an antenna supporting radio waves of a frequency band used for telematics, vehicle to everything (V2X) (vehicle-to-vehicle communication, road-to-vehicle communication), Wi-Fi, Bluetooth, and the like, for example. Further, the antenna 20 may support communication by Multiple-Input Multiple-Output (MIMO) as described below.

The antenna 20 includes an element 21 and shares the feed part 12 with the antenna 10.

The element 21 is a flat-plate-shaped conductive member and is formed so as to extend in the rear direction from the upper end of the feed part 12. The element 21 includes a first extension part 21A and a second extension part 21B.

The first extension part 21A is a part extending in the horizontal and rear directions from the upper end of the feed part 12. The second extension part 21B is a part extending in the down direction from a rear end of the first extension part 21A. A lower end of the second extension part 21B is connected to the ground part 3 by using a connector such as a screw and is also electrically connected to the ground part 3. Note that a method such as soldering or welding may be used for the connection of the second extension part 21B and the ground part 3.

The length along the shape of the antenna 20 from the feed point 12A to a connecting part with the ground part 3, i.e., from the feed point 12A to a short-circuit end is equal to approximately a half-wavelength of radio waves in the 2 GHz band (as an example, the center frequency) (indicated by the arrow with a circled number 3 in FIG. 2A). By setting the length of the antenna 20 to a half-wavelength of the supported frequency band, the sensitivity of the antenna 20 in the supported frequency band can be improved.

Note that the end of the antenna 20 may be an open end as illustrated in FIG. 2B. In this case, by setting the length of the antenna 20 to approximately a quarter-wavelength of radio waves in the supported frequency band (as an example, the center frequency) (indicated by the arrow with a circled number 3 in FIG. 2B)), the sensitivity of the antenna 20 in the supported frequency band can be improved. Note that the wavelength of the supported frequency band indicated by the arrow with the circled number 1 in FIG. 2B is similar to that in FIG. 2A.

<Parasitic Element 30>

The parasitic element 30 is a flat-plate-shaped conductive member mechanically and electrically connected to the ground part 3 and functions to adjust the impedance of the antenna 10. The parasitic element 30 includes a first extension part 31 extending in the front-rear direction and a second extension part 32 extending in the down direction from a rear end of the first extension part 31 (cf. FIGS. 1A-1C and 2A-2B).

The first extension part 31 is a part formed in a substantially rectangular shape when viewed from the top. The first extension part 31 extends in the front-rear direction and faces the ground part 3 in the up-down direction with the holding member 60 interposed therebetween. The distance (height in the up-down direction) of the first extension part 31 from the ground part 3 is shorter than the wavelength of the supported frequency band (699 MHz to 894 MHz) of the antenna 10 and is substantially equal to the distance of the first extension part 11A, the second extension part 11B, and the first extension part 21A from the ground part 3. As illustrated in FIGS. 1A-1C, a front end of the first extension part 31 faces the end 11C in the front-rear direction.

Note that the distance of the first extension part 31 from the ground part 3 (D1 in FIG. 2A) need not necessarily be equal to the distance of the first extension part 11A and the second extension part 11B from the ground part 3 (D2 in FIG. 2A). Hence, the front end of the first extension part 31 may be located in the down direction or the up direction compared with the end of the second extension part 11B.

The second extension part 32 is a part formed in a rectangular shape when viewed in the left-right direction and extends vertically to connect the rear end of the first extension part 31 and the ground part 3. A lower end of the second extension part 32 is connected to the ground part 3 by using a connector such as a screw and is also electrically connected to the ground part 3. The length along the shape of the first extension part 31 and the second extension part 32 from the front end of the first extension part 31 to the short-circuited end is indicated by the arrows each with a circled number 2 in FIGS. 2A and 2B. Note that a method such as soldering or welding may be used for the connection between the second extension part 32 and the ground part 3.

Note that each of the extending directions of the first extension part 11A, the second extension part 11B, and the first extension part 21A and the extending direction of the first extension part 31 is not limited to directions parallel to the plane of the ground part 3, and may be a direction inclined at a predetermined angle with respect to the direction parallel to the plane of the ground part 3. The first extension part 11A and the second extension part 11B (element 11) and the first extension part 21A correspond to a “body part” in the present disclosure.

<Circuit Board 50>

The circuit board 50 is a rectangular member attached to an upper surface of the ground part 3 and is electrically connected to the feed point 12A. The circuit board 50 is provided with a capacitor (not illustrated) and is connected in series with the antennas 10 and 20 via the feed point 12A. The capacitance of the capacitor is set according to the characteristics of the antenna 10.

<Holding Member 60>

The holding member 60 is a member formed of an insulator such as resin and functions to support the antennas 10 and 20 and the parasitic element 30. In particular, the holding member 60 places, on an upper surface thereof, the antennas 10 and 20 and the parasitic element 30 and maintains the shapes of the antennas 10 and 20 and the parasitic element 30. The holding member 60 supports the first extension part 11A, the second extension part 11B, and the first extension part 21A so that the distance from the ground part 3 is constant.

In the holding member 60, two pairs of locking parts 61 each having an L-shaped upper end are provided on a plane facing each of the first extension part 11A of the element 11 of the antenna 10 and the first extension part 31 of the parasitic element 30. The locking parts 61 are inserted into hole parts 11D of the first extension part 11A of the element 11 of the antenna 10 and hole parts 31A formed in the first extension part 31 of the parasitic element 30, and are slid in the front-rear direction to hold the element 11 in place. In this way, positioning of the element 11 of the antenna 10 and the parasitic element 30 with respect to the holding member 60 is facilitated, and further, the distance between the element 11 (21) of the antenna 10 (20) and the parasitic element 30 is kept constant, which can maintain stable antenna performance.

Note that a rib may be provided near an edge part of the holding member 60 to position the element 11 (21) of the antenna 10 (20) and the parasitic element 30 with respect to the holding member 60.

It is apparent that the element 11 (element 21) of the antenna 10 (20) may be fixed to and held by the holding member 60 by integral molding, welding, or screwing, without providing the locking parts 61 and the holes (notches) described above. Note that, in this case, equipment for integral molding or welding, a jig for screws, or the like is needed. In contrast, in a case of holding in place by the locking parts 61 and the holes (notches), there is an advantage that the assembly can be easily performed with no need of such equipment or jig.

<Arrangement of Parasitic Element 30>

As described below, the impedance characteristics of the antenna 10 are adjusted by the size or position of the parasitic element 30.

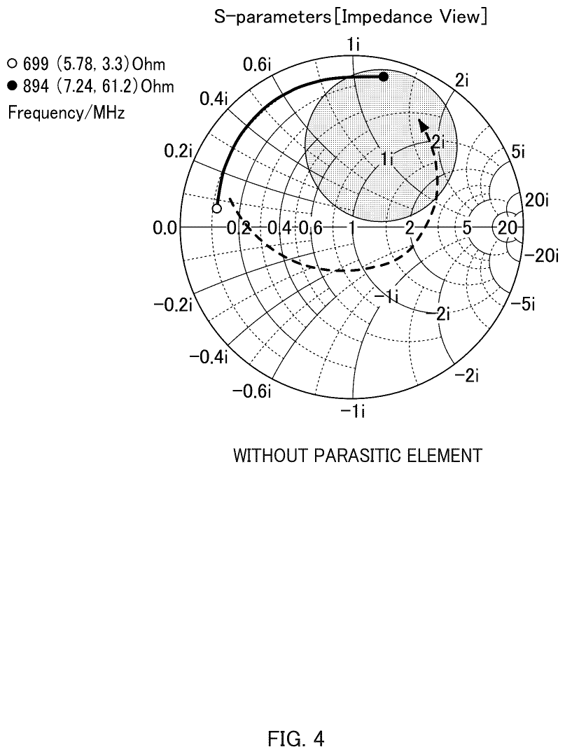

Impedance characteristics of the antenna 10 in the absence of the parasitic element 30 is illustrated in FIGS. 3A and 4. FIG. 3A illustrates the impedance of the antenna 10 with a graph with a dotted line in a Smith chart normalized to 50Ω (ohms), and the start point and the end point of the graph are 600 MHz and 1000 MHz, respectively. The markers with numbers 1 and 2 in the graph correspond to the minimum value (699 MHz) and the maximum value (894 MHz) of the supported frequency band of the antenna 10. FIG. 4 illustrates only the distribution in the supported frequency band of the antenna 10 in FIG. 3A, as a solid line.

As illustrated in the drawing, the impedance of the antenna 10 is distributed along a constant resistance circle (indicated by a solid line) in the Smith chart. In the present embodiment, by installing the parasitic element 30, the impedance of the antenna 10 is adjusted so as to be distributed above the real axis of the Smith chart. This is because, in order to perform impedance matching to adjust the impedance to be a constant impedance (for example, 50 ohms) between 699 MHz and 894 MHz, it is preferable that the impedance be in the upper half of the Smith chart, which will be described below in detail.

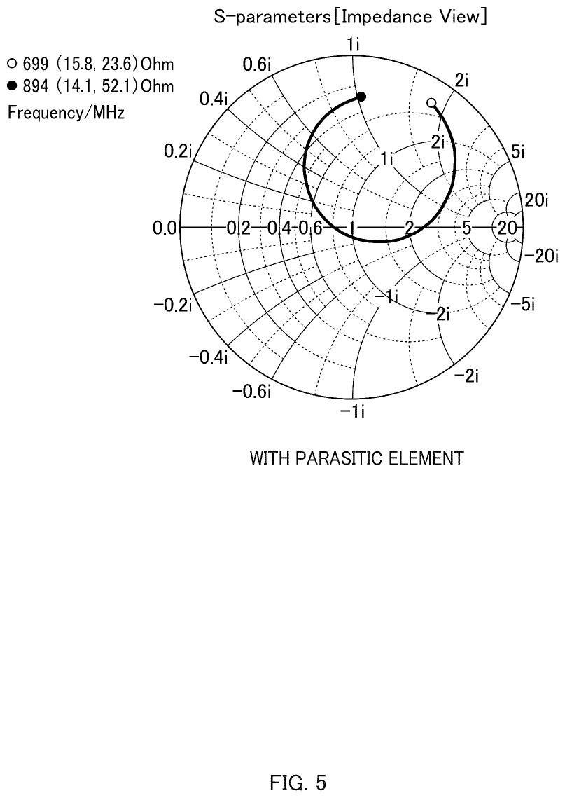

FIGS. 3B and 5 illustrate impedance characteristics of the antenna 10 when the parasitic element 30 is installed. FIG. 3B illustrates the impedance characteristics (dotted line) and a distribution of a voltage standing wave ratio (VSWR) of 3.5 (solid line). The range of impedance characteristics and a method of normalization are the same as those for FIG. 3A. FIG. 5 illustrates only the distribution in the supported frequency band of the antenna 10 in FIG. 3B. As illustrated in the drawing, the impedance of the antenna 10 is largely distributed above the real axis of the Smith chart. Comparing FIGS. 4 and 5, the distribution shape of the impedance changes and also moves into or near the shaded range as indicated by the dotted arrow in FIG. 4. The distribution shape of the impedance in FIG. 3B, different from that in FIG. 3A, forms an are having a large curvature and falls within a certain range in the Smith chart.

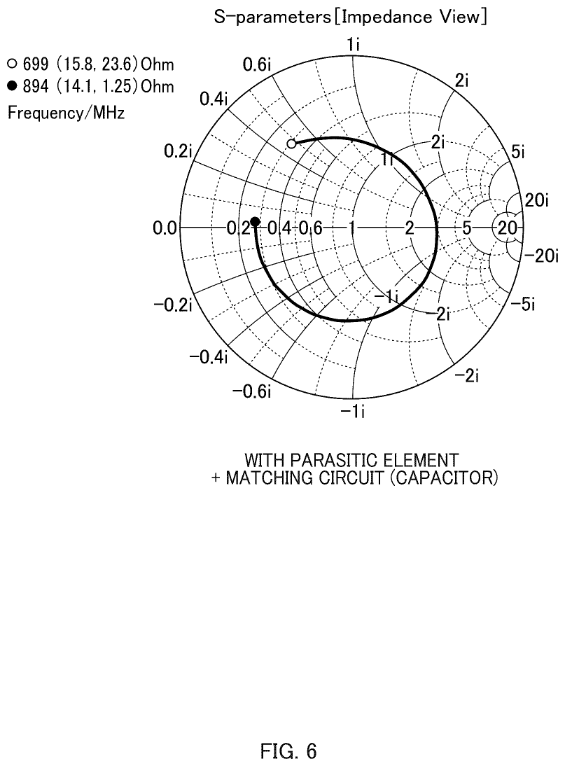

FIG. 6 is a Smith chart illustrating the impedance characteristics of the antenna 10 when the parasitic element 30 is present and a capacitor of 3.5 pF is further added in series to the antenna 10. The capacitor increases the capacitance component of the impedance, and the impedance graph slides downward as indicated by the arrow with “series C” in FIG. 3B. As a consequence, as illustrated in FIGS. 3B and 6, the impedance is distributed in an arc shape near a VSWR of 3.5 around a value of 1.0 (50Ω) on the real axis and falls within a certain range.

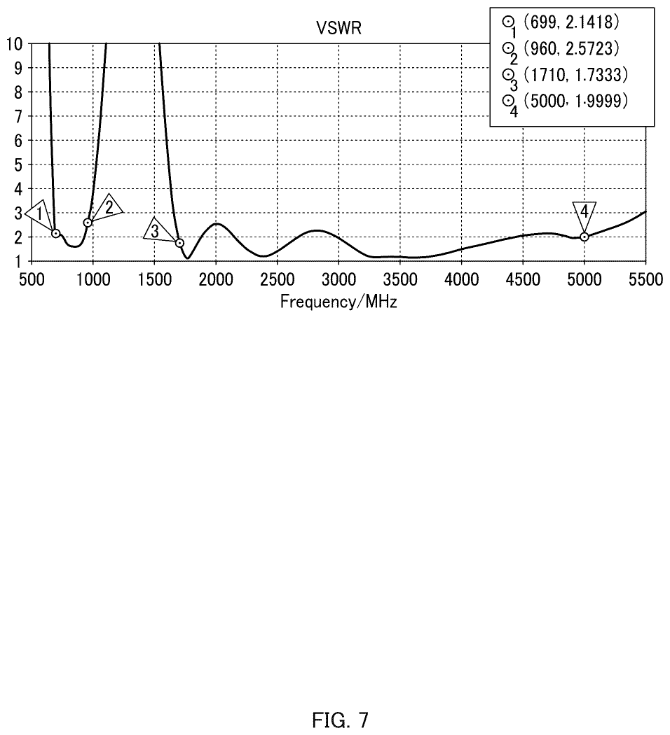

As illustrated in FIG. 7, the VSWR of the antenna 10 to which the capacitor of 3.5 pF is added falls within 3.5 or less in the 699 MHz to 894 MHz frequency band. As described above, the parasitic element 30 contributes to the adjustment of the impedance characteristics of the antenna 10 and exhibits good VSWR characteristics over a wide band. Note that the capacitor of 3.5 pF is provided to the circuit board 50 illustrated in FIG. 1A and is supplied with a current that contributes to adjustment of the impedance characteristics of the antenna 10 via the feed point 12A in FIGS. 2A-2B.

As described above, the impedance characteristics of the antenna 10 can be adjusted according to the position and shape of the parasitic element 30. Hence, in order to make the impedance characteristics of the antenna 10 conform to design conditions and the like, the parasitic element 30 can take various shapes or positions other than the positions and shapes illustrated in FIGS. 1A-1C and the like. Hereinafter, the relationship between the position and shape of the parasitic element 30 and the impedance characteristics of the antenna 10 will be described.

(Distance Between Parasitic Element 30 and Antenna 10)

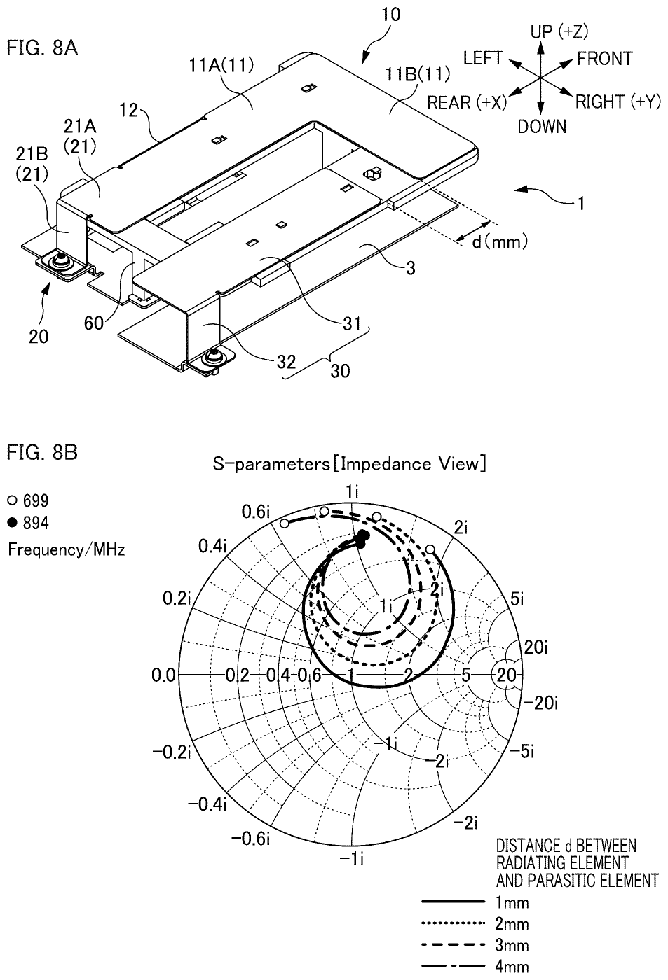

As an example, it is possible to adjust the impedance characteristics of the antenna 10 by changing the distance between the parasitic element 30 and the antenna 10. FIGS. 8A-8B illustrates the relationship of a configuration of the antenna 10 with respect to the distance between the front end of the first extension part 31 and the end of the second extension part 11B and the impedance of the antenna 10 (without capacitor connection).

In the configuration of the antenna 10 of the antenna device 1 illustrated in FIG. 8A, the distance (distance d) between the front end of the first extension part 31 and the end of the second extension part 11B is changed by 1 mm at a time in a range of 1 mm or more and 4 mm or less. The distance d is changed by the parasitic element 30 being shifted forward and rearward while maintaining the same shape.

As illustrated in the Smith chart in FIG. 8B, it can be seen that the distribution of the impedance of the antenna 10 changes by adjusting the distance d. When the distance d is increased, the parasitic capacitance between the antenna and the parasitic element 30 decreases to increase the inductor component, which moves the impedance to an upper part of the Smith chart over a wide band. By changing the distribution of the impedance as described above, the impedance can be distributed above the real axis in the Smith chart, preferably to fall within a certain range such as the shaded part in FIG. 4.

(Length of Parasitic Element 30)

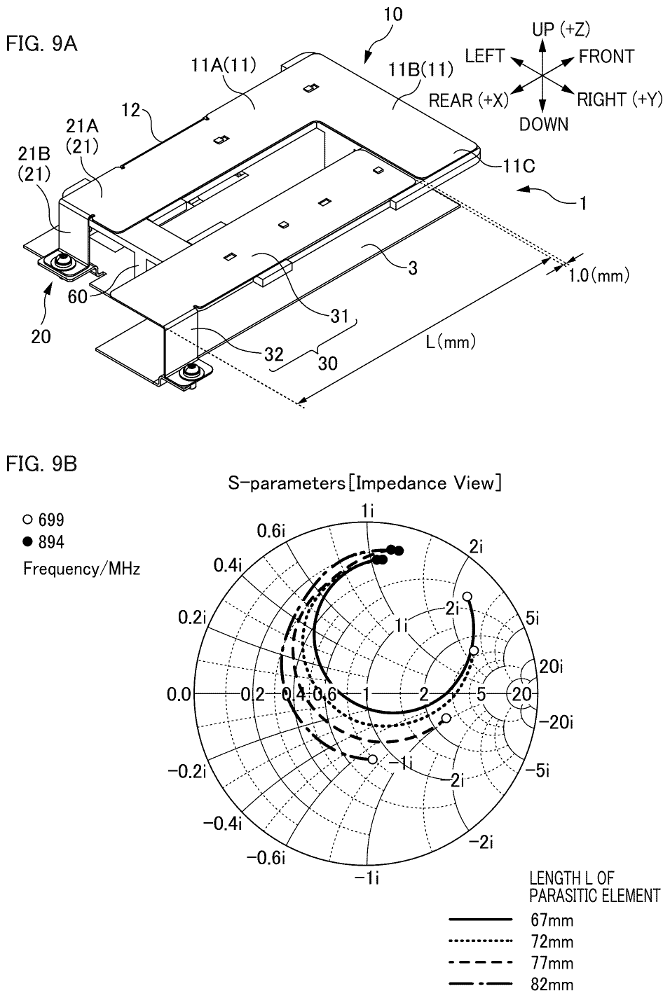

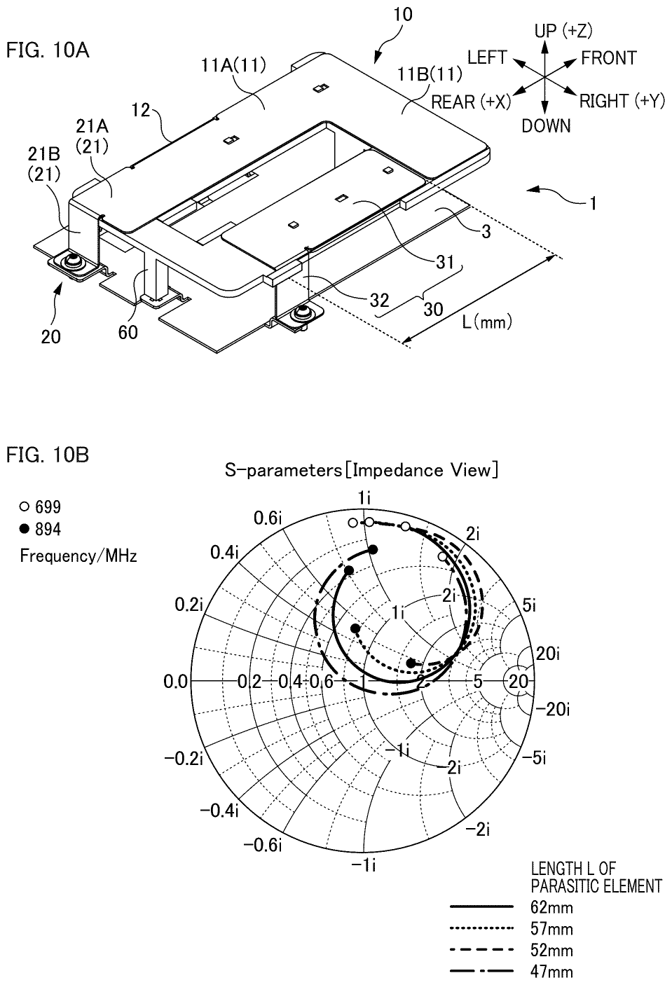

As an example, the impedance characteristics of the antenna 10 can be adjusted by changing the length of the parasitic element 30. In FIGS. 9A and 10A, a configuration illustrating the front-rear direction length of the first extension part 31 and a relationship of the impedance of the antenna 10 (without capacitor connection) to the length of the first extension part 31 are illustrated. In FIGS. 9A and 10A, a length L of the first extension part 31 is changed by 5 mm at a time in a range of 47 mm or more and 82 mm or less. The distance between the front end of the first extension part 31 and the end 11C is maintained at 1 mm. Note that the front-rear direction length L of the first extension part 31 of the parasitic element 30 is set to be longer than the front-rear direction length of the first extension part 11A of the antenna 10 arranged so as to face the first extension part 31 in FIG. 9A, and is set to be shorter than the front-rear direction length of the first extension part 11A of the antenna 10 arranged so as to face the first extension part 31 in FIG. 10A.

As illustrated in the Smith charts in FIGS. 9B and 10B, it can be seen that the distribution of the impedance of the antenna 10 changes by adjusting the front-rear direction length of the first extension part 31. In this way, the impedance can be distributed above the real axes in the Smith charts, preferably to fall near or within a certain range such as the shaded part in FIG. 4.

(Width of Parasitic Element 30)

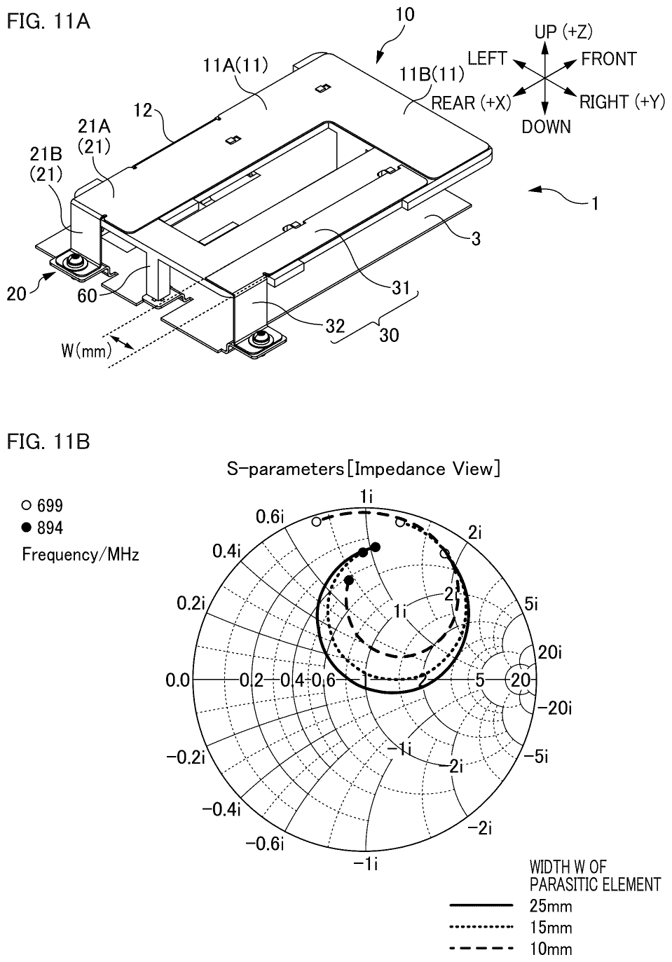

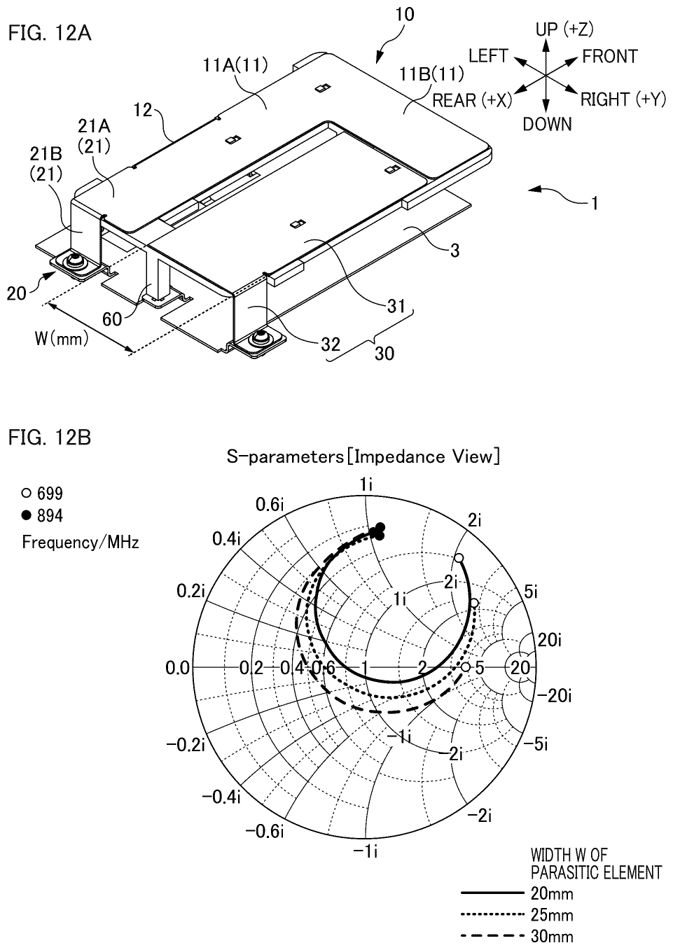

The impedance characteristics of the antenna 10 can also be adjusted by changing the width of the parasitic element 30. In FIGS. 11A and 12A, a configuration illustrating the width of the first extension part 31 and a relationship of the impedance of the antenna 10 (without capacitor connection) to the width, i.e., the left-right direction length, of the first extension part 31 are illustrated. In FIGS. 11A and 12A, a width W of the first extension part 31 is changed by 5 mm at a time in a range of 10 mm or more and 30 mm or less. The distance between the front end of the first extension part 31 and the end 11C is set at 1 mm, and the front-rear direction length is set at 67 mm. The width W of the first extension part 31 of the parasitic element 30 is set to be narrower in FIG. 11A than the width of the first extension part 31 illustrated in FIGS. 1A-1C while being set to be wider in FIG. 12A than the width of the first extension part 31 illustrated in FIGS. 1A-1C.

As illustrated in the Smith charts in FIGS. 11B and 12B, it can be seen that the distribution of the impedance of the antenna 10 changes by changing the width of the first extension part 31. In this way, the impedance can be distributed above the real axes in the Smith charts, preferably to be near or within a certain range such as the shaded part in FIG. 4.

(Variations of Parasitic Element 30)

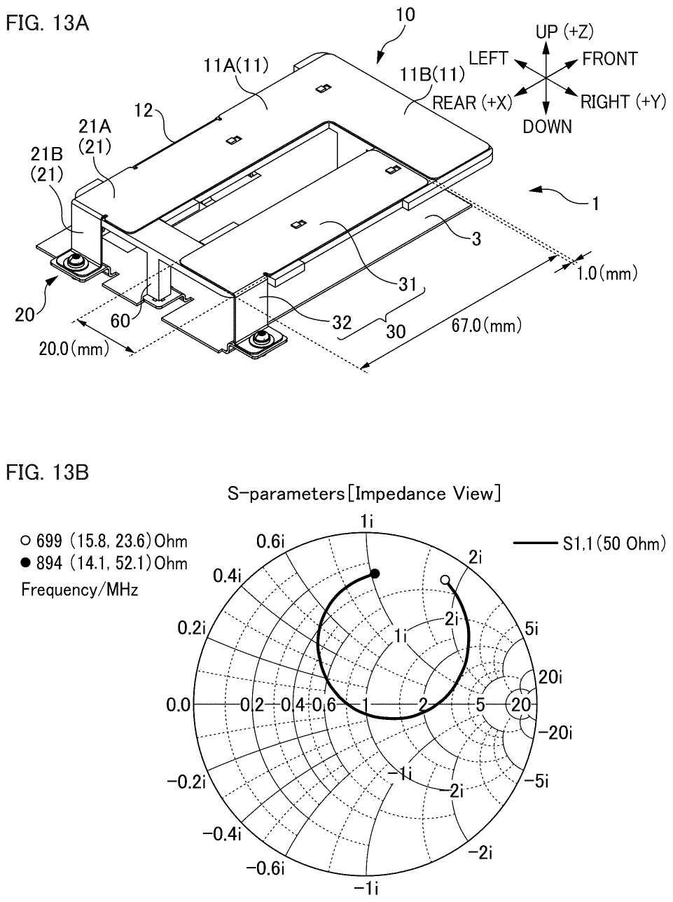

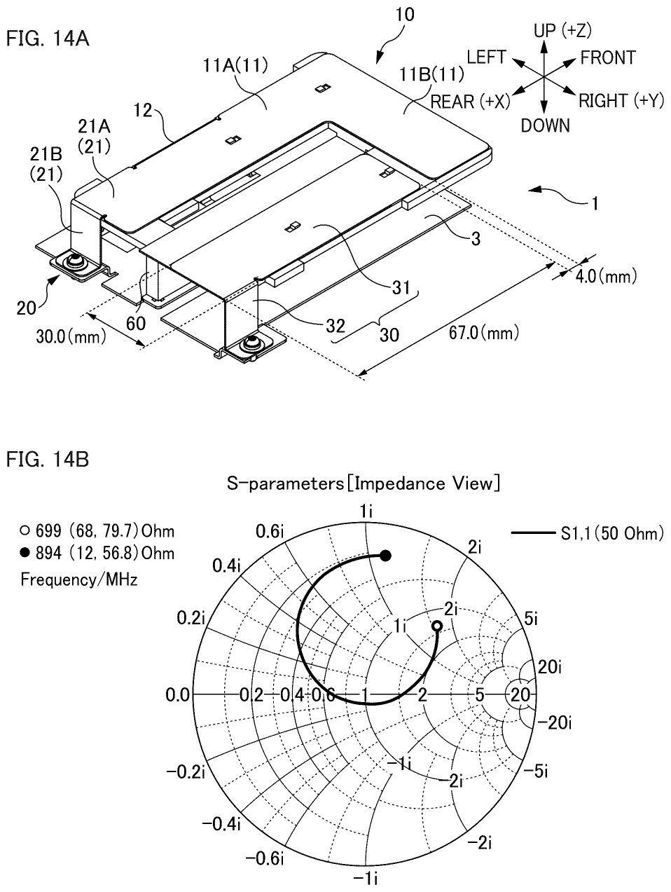

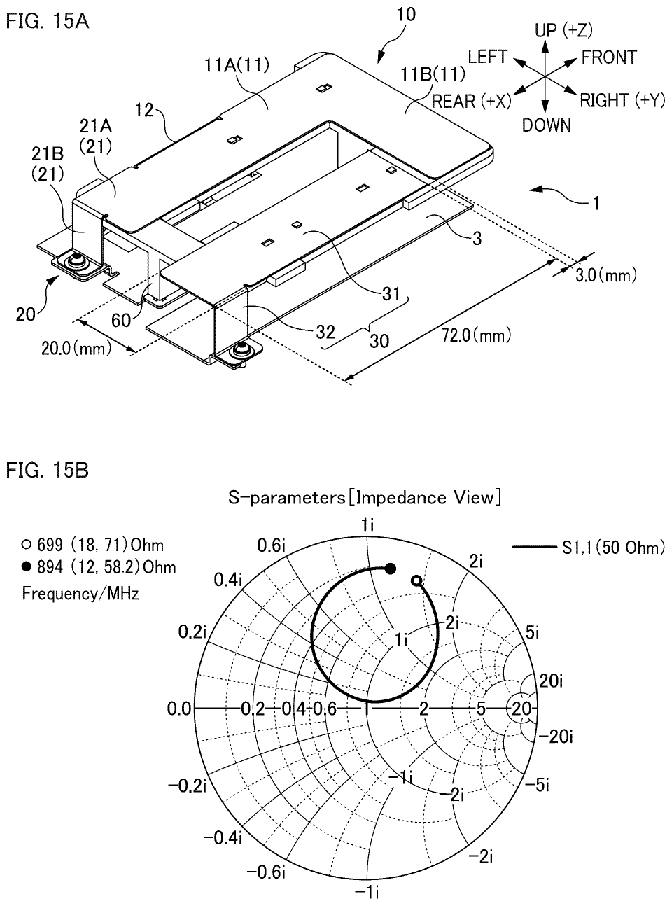

Examples of the parasitic element 30 designed under the above considerations are illustrated in FIGS. 13A to 15B, with the indication of the width and the length of the first extension part 31 and the distance from the end of the second extension part 11B. In all of the examples illustrated in the diagrams, the impedance of the antenna 10 is mostly distributed above the real axis of the corresponding Smith chart. Hence, it can be seen that there are various variations in the width, the length, and the distance to the end 11C, of the first extension part 31, which contribute to adjustment of the impedance.

### Second Embodiment

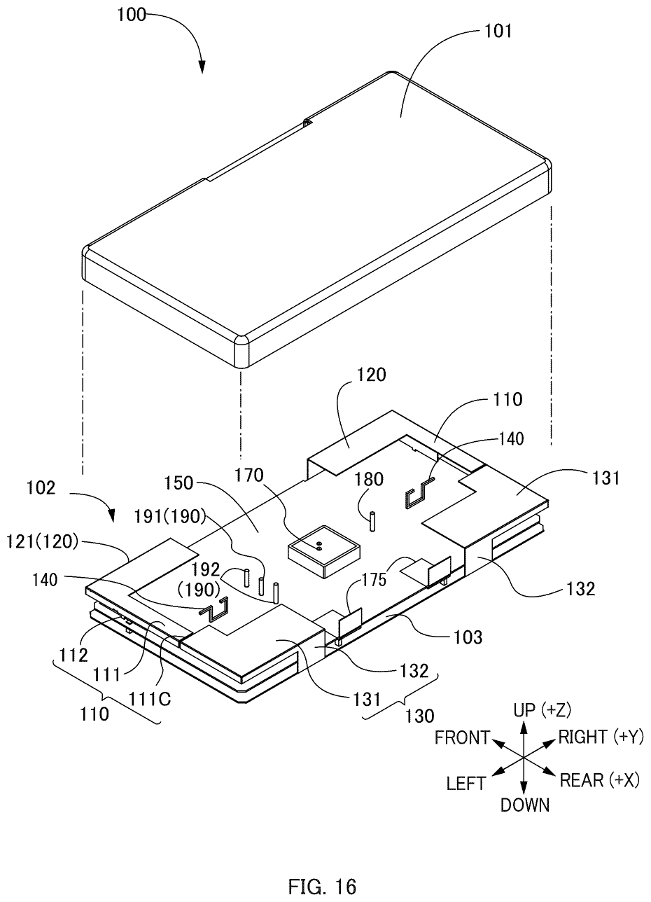

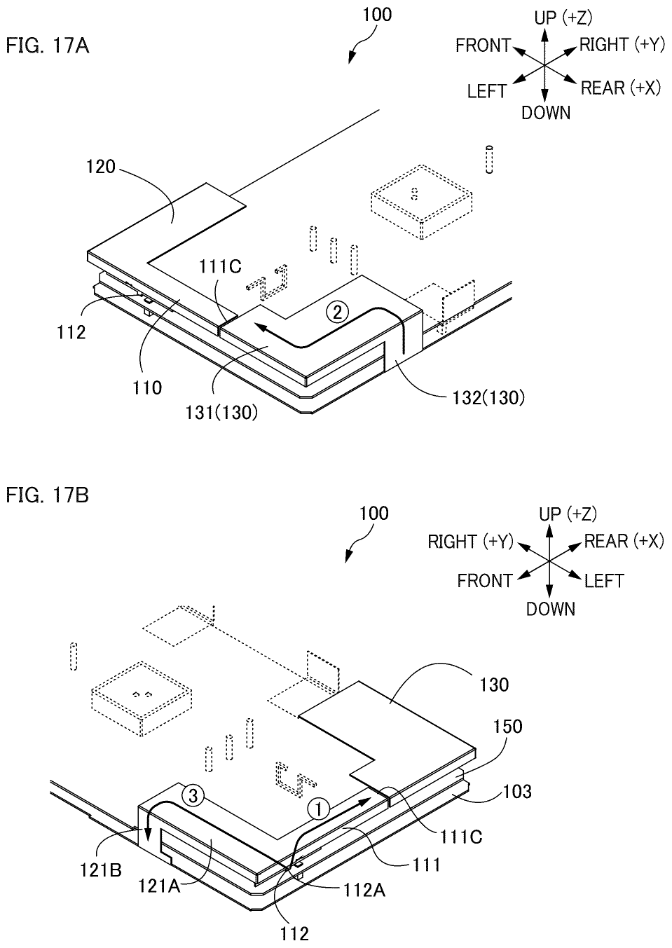

An antenna device 100 according to a second embodiment is illustrated in FIGS. 16 and 17A-17B.

The antenna device 100 includes a ground part 103, an antenna 102 (antenna 110 and antenna 120), a parasitic element 130, a circuit board 150, a holding member (not illustrated) that holds the antenna 102, and a housing 101 that covers these members from above. The antenna device 100 includes a flat-plate-shaped patch antenna 170 (to be used for a global navigation satellite system (GLASS)) placed on the circuit board 150, two bent rod-shaped Wi-Fi/Bluetooth (trademark) antennas 140 (supporting 2.4/5 GHz band), and two bent plate-shaped Sub-6 antennas 175 (supporting a frequency band of lower than 6 GHz). Note that the Wi-Fi/Bluetooth antennas 140 are not limited to a rod shape and may be a plate shape, may be formed by punching a conductor plate, or may be formed by forming a conductive pattern on a PCB. In addition, the antenna device 100 includes a rod-shaped V2X monopole antenna 180 extending in the up direction from the circuit board 150 and a V2X antenna 190 including parasitic elements 192 and a radiating element 191.

The patch antenna 170 arranged on the circuit board 150 is arranged substantially at the center of the circuit board 150. The V2X monopole antenna 180 and the radiating element 191 of the V2X antenna 190 are arranged on a line passing substantially through the center of the patch antenna 170 in the left-right direction with the patch antenna 170 interposed therebetween. The parasitic elements 192 are arranged at a predetermined distance on both front-and-rear direction sides of the radiating element 191 of the V2X antenna 190. In FIG. 16, a parasitic element is provided only in the V2X antenna 190 on the left direction side with respect to the patch antenna 170, but a parasitic element may also be provided in the V2X monopole antenna 180 on the right direction side.

Note that the V2X antenna 190 has directional characteristics in the front direction, and the V2X monopole antenna 180 has directional characteristics in the right direction. In the antenna device 100, particularly, by providing the parasitic elements 192 to the V2X antenna 190 in the left direction, the gain of the directivity in the left direction can be improved.

The two Wi-Fi/Bluetooth antennas 140 are arranged on a line passing substantially through the center of the patch antenna 170, at a position apart from each other in the left-right direction with the patch antenna 170 interposed therebetween. Further, the two Wi-Fi/Bluetooth antennas 140 are disposed between the antenna 120 and the parasitic element 130 in the front-rear direction, an arrangement that achieves both interference suppression and size reduction.

The patch antenna 170 is suitable for an antenna of a satellite positioning system capable of receiving circularly polarized signals by various feeding systems such as a double-feed system or a a quadruple-feed system. Any antenna may be a patch antenna structure as long as it is an antenna supporting a satellite signal, such as a stacked antenna, a multi-resonance antenna, or an antenna with a parasitic element further added.

The antenna device 100 includes, in each of the left part and the right part thereof, one antenna 110, one antenna 120, one parasitic element 130, and one holding member (not illustrated). These members are substantially bilaterally symmetrically. Hereinafter, the antenna 110, the antenna 120, and the parasitic element 130 arranged in the left direction will be mainly described with reference to FIGS. 17A-17B. The antenna 110, the antenna 120, and the parasitic element 130 arranged in the right direction have a similar configuration to that of the left direction, and therefore, description thereof is omitted.

The ground part 103 is a rectangular member extending horizontally and has a similar function to that of the ground part 3. In other words, the ground part 103 functions as grounds of the antenna 110, the antenna 120, and the parasitic element 130 included in the antenna device 100. Like the ground part 3, the ground part 103 functions as a common ground of the antenna 110 and the antenna 120. As illustrated in FIG. 16, the ground part 103 is formed as an integral metal plate (sheet metal). However, alternatively the ground part 103 may be constituted of a plurality of separate metal plates.

The antenna 110 is a wideband antenna for mobile communication based on an inverted-L antenna having a similar function to that of the antenna 10. The antenna 110 includes an element 111 and a feed part 112.

The element 111 is a plate-shaped member extending horizontally. The element 111 is formed so as to extend in the rear direction from the feed part 112 and faces the ground part 103 vertically. An end 111C, which is an open end, is formed at a rear end of the element 111 and faces the parasitic element 130 in the front-rear direction.

The feed part 112 is formed so as to extend in the up direction from an upper surface of the circuit board 150. The feed part 112 is in contact, at a lower end thereof, with the circuit board 150 and includes a feed point 112A electrically connected to the circuit board 150. Note that an upper end (element 111 side) of the feed part 112 has a shape in which the front-rear direction width is larger than a lower end (circuit board 150 side).

As indicated by the arrow (circled number 1) in FIG. 17B, the length along the shape of the antenna 110 from the feed point 112A to the end 111C is equal to a quarter-wavelength of radio waves in the 699 MHz to 894 MHz band. By setting the length of the antenna 110 at a quarter-wavelength of the supported frequency band, the sensitivity of the antenna 110 in the supported frequency band can be improved.

The antenna 120 is a wideband antenna for mobile communication based on a folded monopole antenna. As the antenna 20, the antenna 120 receives radio waves in the 2 GHz band (e.g., 1710 to 2170 MHz). The antenna 120 may support radio waves in a frequency band for GSM, UMTS, LTE, and 5G. The antenna 120 may be an antenna supporting radio waves of a frequency band used for telematics, vehicle to everything (V2X) (vehicle-to-vehicle communication, road-to-vehicle communication), Wi-Fi, Bluetooth, and the like, for example.

The antenna 120 includes an element 121 and shares the feed part 112 with the antenna 110.

The element 121 is a flat-plate-shaped conductive member and is formed so as to extend in the right direction from the upper end of the feed part 112 (FIG. 17B). The element 121 includes a first extension part 121A and a second extension part 121B.

The first extension part 121A is a part extending in the right direction from the upper end of the feed part 112. The second extension part 121B is a part extending in the down direction from a right end of the first extension part 121A. The lower end of the second extension part 121B is mechanically and electrically connected to the ground part 103. Note that, for connect ion of the second extension part 121B and the ground part 103, a joint method via a joint element such as a screw or a method such as soldering or welding is used.

As indicated by an arrow (circled number 3) in FIG. 17B, the electrical length along the shape of the antenna 120 from the feed point 112A to the lower end of the second extension part 121B is equal to approximately a half-wavelength of radio waves in the 2 GHz band (for example, radio waves of the center frequency). By setting the electrical length of the antenna 120 to a half-wavelength of radio waves in the supported frequency band, the sensitivity of the antenna 120 in the supported frequency band can be improved.

The parasitic element 130 is a flat-plate-shaped conductive member mechanically and electrically connected to the ground part 103, and functions to adjust the impedance of the antenna 110 as the parasitic element 30 (FIG. 17A). The parasitic element 130 includes a first extension part 131 extending in the left-right direction and the front-rear direction and a second extension part 132 extending in the down direction from a right end of the first extension part 131.

The first extension part 131 is a part formed so as to be bent in an L shape when viewed from the top. The first extension part 131 faces the ground part 103 in the up-down direction. The height of the first extension part 131 from the ground part 103 is approximately equal to the height of the element 111 from the ground part 103.

The first extension part 131 extends in the left direction from the upper end of the second extension part 132 and is bent, at a left end thereof, in the front direction. The front end of the first extension part 131 forms an open end and faces the end 111C of the element 111 at a distance.

The second extension part 132 is a part formed in a rectangular shape when viewed in the front-rear direction and extends vertically to connect the right end of the first extension part 131 and the ground part 103. A lower end of the second extension part 132 is mechanically and electrically connected to the ground part 103 by using a connector such as a screw. Note that, for connection of the second extension part 132 and the ground part 103, a joint method via a joint element such as a screw or a method such as soldering or welding is used.

The circuit board 150 is a rectangular member arranged above the ground part 103 and is electrically connected to the feed point 112A. The circuit board 150 is provided with a capacitor (not illustrated) and is connected in series with the antennas 110 and 120 via the feed point 112A.

Also in the above-described configuration, as in the first embodiment, the impedance characteristics of the antenna 110 are adjusted by the length along the shape of the parasitic element 130 (indicated as an arrow with a circled number 2 in FIG. 17A), the width of the parasitic element 130, or the distance of the parasitic element 130 from the antenna 10. As a result of designing the parasitic element 130 with such adjustment, the antenna 110 exhibits desired impedance characteristics. In addition, the antenna 110 is connected to the capacitor on the circuit board 150 and can thereby exhibit good VSWR characteristics in the supported frequency band.

### Effects

In each of the above-described embodiments, the antenna device 1, 100 includes the ground part 3, 103, the antenna 2, 102, and the parasitic element 30, 130. The antenna 2, 102 includes the element 11, 111 (corresponding to a “body part”) including an open end facing the ground part 3, 103 and being open, and the feed part 12, 112 extending from the element 11, 111 toward the ground part 3, 103 and including the feed point 12A, 112A. The parasitic element 30, 130 includes a first end located at a distance from the open end of the element 11, 111 and is used to adjust the impedance of the antenna 10, 110.

According to the above configuration, by providing the parasitic element 30, 130, the impedance characteristics of the antenna 10, 110 can be adjusted and the performance of the antenna 10, 110 can be improved over a wide band.

In addition to the above configuration, the length from the feed point 12A, 112A to the open end through the antenna 10, 110 is a length corresponding to the supported frequency band of the antenna 10, 110.

With such a configuration, radio waves in the supported frequency band can be satisfactorily transmitted and received.

In addition to the above configuration, the distance between the element 11, 111 and the ground part 3, 103 is shorter than the wavelength of the supported frequency band of the antenna 10, 110.

With the above-described configuration, the antenna device 1, 100 can be reduced in height, in other words, can be reduced in vertical height to be thereby made more compact. The parasitic element 30, 130 contributes to achieving the reduction in size. Specifically, as illustrated in FIGS. 3A-3B and 7, the impedance of the antenna 10, 110 is adjusted by the parasitic element 30, 130, so that VSWR characteristics can be improved over a wide band. Hence, in the above-described embodiments, the element 11, 111 is arranged at a low position, to thereby achieve a reduction in size of the entire device. With such compactness, the antenna device 1, 100 can be located even in a narrow space.

In addition to the above-described configuration, the parasitic element 30, 130 is arranged to increase an inductance component of impedance in the supported frequency band.

With the above-described configuration, as illustrated in FIG. 5, the impedance can be distributed to an upper part of a Smith chart, and the impedance adjustment using an element such as a capacitor (FIG. 6) can be facilitated. When the impedance of the supported frequency band is located above the real axis in the Smith chart, the distribution of the impedance can be slid downward in the Smith chart by increasing the conductance component using the capacitor, which can facilitate impedance adjustment.

In each of the above-described embodiments, by connecting a capacitor configured to increase the capacitance component of the impedance in the supported frequency band, to the antenna 10, 110, the impedance is adjusted so as to fall within a certain range with the center of 50Q in the Smith chart (FIG. 6). In this way, good VSWR characteristics can be obtained.

The feed part 12 has a width (front-rear length) larger than that of the feed point 12A at a part connected to the element 11. Hence, it is possible to support a higher frequency band than the supported frequency band and to obtain high performance over a wide band.

The antenna 2, 102 includes the second extension part 21B, 121B (corresponding to a “connecting part”) that connects the first extension part 21A, 121A (corresponding to the “body part”) and the ground part 3, 103.

With this configuration, the antenna 2, 102 has the function of the antenna 20, 120 supporting a frequency band different from both the supported frequency band of the antenna 10, 110 and the supported frequency band of the feed part 12.

The distance D2 (corresponding to a “first distance”) of the end of the second extension part 11B in the up-down direction from the ground part 3 is the same as the distance D1 (corresponding to a “second distance”) of the front end of the first extension part 31 in the up-down direction from the ground part 3. In addition, the distance of the front end of the element 111 in the up-down direction from the ground part 103 is the same as the distance of the front end of the first extension part 131 in the up-down direction from the ground part 103.

As described above, by making the end of the element 11, 111 and the end of the parasitic element 130, 130 facing the end of the element 11, 111 uniform in terms of height so as to be in the same plane, which can reduce the height of the antenna device 1, 100, i.e., can reduce the up-down direction height, the antenna device 1, 100 can be made compact.

### REFERENCE SIGNS LIST

1, 100: Antenna device;
2, 102: Antenna;
3, 103: Ground part;
12, 112: Feed part;
12A, 112A: Feed point;
30, 130: Parasitic element;
50: Circuit board;
60: Holding member.

1. An antenna device comprising:
a ground part;
an antenna, including a body part having an open end facing and open to the ground part and a feed part extending from the body part in a direction of the ground part and having a feed point; and
a parasitic element for impedance adjustment of the antenna, including a first end located at a distance from the open end.

2. The antenna device according to claim 1, wherein a length from the feed point to the open end through the antenna is a length corresponding to a first frequency band.

3. The antenna device according to claim 2, wherein the length is approximately a quarter-wavelength of the first frequency band.

4. The antenna device according to claim 2, wherein a distance between the body part and the ground part is shorter than a wavelength of the first frequency band.

5. The antenna device according to claim 2, wherein the parasitic element is disposed so as to increase an inductance component of an impedance of the first frequency band.

6. The antenna device according to claim 2, further comprising a capacitor connected to the antenna and configured to increase a capacitance component of an impedance of the first frequency band.

7. The antenna device according to claim 2, wherein the feed part has a larger width at a portion connected to the body part than a portion corresponding to the feed point, to support a second frequency band higher than the first frequency band.

8. The antenna device according to claim 7, wherein the antenna includes a connecting part configured to connect the body part and the ground part, to support a third frequency band different from both the first frequency band and the second frequency band.

9. The antenna device according to claim 1, wherein, in a vertical direction of the ground part, a first distance of the first end from the ground part is the same as a second distance of the open end from the ground part.
